(19) United States
(12) Patent Application Publication
(10) Pub. No.: US 2007/0208916 A1
(43) Pub. Date: Sep. 6, 2007

(54) Data-recording method, data-recording apparatus, and data-recording system

(75) Inventor: Nobuyoshi Tomita, Tokyo (JP)

Correspondence Address: Randy J. Pritzker;Wolf, Greenfield & Sacks, P.C., 600 Atlantic Avenue, Boston, MA, 02210-2206, US

(73) Assignee: Sony Corporation, Tokyo (JP)

(21) Appl. No.: 11/054,624

(22) Filed: Feb. 9, 2005

(30) Foreign Application Priority Data
Feb. 10, 2004 (JP) JP2004-033992

(51) Int. Cl. G06F 12/16

(52) U.S. Cl. 711/162

(57) ABSTRACT

A PC, which is a data-processing apparatus copies a file in a mini disc via a data-recording apparatus. The file is composed of a copyrighted music content accumulated in the HDD of the PC, which have been reproduced from another recording medium such as a CD, a DVD or the like. The data-recording apparatus records the ID specific to the PC in the mini disc. Not only the music file, but also the content ID specific to the content is recorded in the next-generation mini disc used in an embodiment of this invention. The music file, thus backed up, is restored when the device in which the content is to be restored is identical to the PC that has been checked out, or when this device is collated to be identical to the PC.

### BACKGROUND OF THE INVENTION

1. Field of the Invention

This invention relates to a data-recording method, a data-recording apparatus, and a data-recording system. More particularly, the invention relates to a data-recording method, a data-recording apparatus, and a data-recording system, all designed to copy a content, which is permitted to be copied only a limited number of times and which is thus copyright-protected, in another recording medium in which data is recorded in a specific format so that the data may be well edited.

This application claims priority of Japanese Patent Application No. 2004-033992, filed on Feb. 10, 2004, the entirety of which is incorporated by reference herein.

2. Description of the Related Art

In recent years, various types of recording media, such as discs, have been developed to require a great storage capacity. It is demanded that various kinds of data, such as audio data and data for use in computers, should be recorded in, and reproduced from, one recording medium. In developing a general-purpose medium, however, it is also important that the medium is compatible with the conventional recording/reproducing apparatus and the like. Further, from a physical point of view, it is desired that the resources hitherto available should be effectively utilized.

The mini disc (MD, registered trademark), which is now put to a widespread use, will be taken for example. As is well known, the mini disc is a magnetooptical disc having a diameter of 64 mm. Audio data, such as music data, can be recorded in, and reproduced from, the mini disc. In the mini disc, audio data is recorded, compressed to ⅕ to 1/10 in ATRAC mode. The mini disc can hold audio data that is played back for about 80 to 160 minutes. The mini disc is a file system in which the recorded data can be well edited. That is, the recorded data can be divided, combined, erased and moved (track-number move) in the mini disc.

A technique has been developed, in which a personal computer (PC) reproduces content data, such as music data and video data, recorded in a package medium such as a CD-DA (Compact Disc Digital Audio) or a DVD (Digital Versatile Disc). The content data thus reproduced is copied or moved from the HDD (Hard Disc Drive) of the PC, used as primary recording medium, to a mini disc used as secondary recording medium. (Such a technique is disclosed in, for example, Jpn. Pat. Appln. Laid-Open Publication No. 2002-373470.)

In the technique disclosed in Jpn. Pat. Appln. Laid-Open Publication No. 2002-373470, data is encrypted before it is transferred between the PC and a terminal device. Even if the content data (data defining an unit of music or the like, also known as “track”) is edited, the right to the content is managed. Further, check-in (right reversion)/check-out (right assignment) matching is realized, as in SDMI (Secure Digital Music Initiative) systems.

A copyright-protected music content may be lost in a PC after it has been checked out to a mini disc, a semiconductor medium, or the like, without backing up any information about the source music content or the music content. In this case, the check-in and the check-out may not be matched, and the music content may not be used. Even if the content is one that the user has downloaded from a related site by taking prescribed procedures, there are no methods of restoring the content now unusable, because the check-in and the check-out cannot be matched at all. Hitherto, a backup of data is prepared, and the data, if lost, is restored from the backup. Thus, a backup of any important data must be prepared.

Data may not be restored due to conditions other than the check-in/check-out condition described above. For example, a storage area of an original storage place becomes full, and some data is erased from the storage area so that new data may be recorded in the storage area. If the data erased has not been backed up, it cannot be restored. Even if the data has been copied in another recording medium, thus making a backup, it cannot be restored unless the user remembers in which medium the data erased is recorded.

### SUMMARY OF THE INVENTION

An object of the present invention is to provide a data-recording method, a data-recording apparatus, and a data-recording system, which can distinguish a content illegally obtained as a user copies a content in bad faith, from a content downloaded through prescribed procedures but not having undergone check-in/check-out matching, which can therefore restore the content even if, for example, a PC malfunctions, and which can prevent illegal copying of the content that may be achieved by restoring the content from a recording medium.

To achieve the object described above, a data-recording method according to this invention comprises: a recording step of first copying a content to another recording medium and recording content information specific to the content and device information specific to a device that is an original storage place of the content; a collating step of collating the content information about the copied content and the device information associated with the content information, with device information about a device in which the content is to be written, when the content is lost in the storage place after the content has been recorded in the recording step; and a restoring step of writing the copied content back into the device when collation is successfully performed in the collating step.

The restoring step has a determining step of determining whether the content to be restored was restored in the past in combination with the recording medium storing the content. The copied content is written back into the device if the collation is successfully performed in the collating step and if the content was not restored in the past. Further, the restoring step may have a step of determining whether the device in which the content is to be restored is identical to the device in which the content has been previously restored. It may also have a step of detecting a restoration interval to determine whether a prescribed period has elapsed from a previous restoring process, and the copied content is written back into the device if the collation is successfully performed in the collating step, if the device in which the content is to be restored is not identical to the device in which the content has been previously restored and if the prescribed period has elapsed from the previous restoring process.

The content information includes index information to be referred to when a music content is reproduced, information for checking possible falsification of the content and information for allowing reproduction for each set. In the data-recording method according to this invention, the coping from the original storage place to the another recording medium is to assign the right of using the content. The method should better be used in combination with a content management method in which the content cannot be used in the original storage place unless the right of moving the content from the another recording medium to the original storage place is reverted.

It is desired that the another recording medium should be one that has a secure region that can be used if verified and an ordinary record region, and that the content should be recorded in the secure region.

To attain the above-mentioned object, a data-recording apparatus according to the present invention comprises: a first recording means for recording, in a storage means, a content input from an external device; a second recording means for copying the content from the storage means to another recording medium and recording content information specific to the content and device information specific to the data-recording apparatus; and a restoring means for collating the content information about the copied content and the device information associated with the content information, with device information about a device in which the content is to be written, when the content is lost in a storage place after the content has been recorded to the another recording medium by the second recording means, and for causing the first recording means to perform a process of writing the copied content back into the original storage place when collation is successfully performed. The content lost is restored when the restoring means determines that the content recorded in the another recording medium is the content that has been copied from the original storage place.

The restoring means determines whether the content to be restored was restored in the past in combination with the recording medium storing the content. It performs a process of writing the copied content back into the device if the collation is successfully performed and if the content was not restored in the past. The restoring means may determine whether the device in which the content is to be restored is identical to the device in which the content has been previously restored, may detect a restoration interval to determine whether a prescribed period has elapsed from a previous restoring process, and may write the copied content back into the device if the collation is successfully performed, if the device in which the content is to be restored is not identical to the device in which the content has been previously restored and if the prescribed period has elapsed from the previous restoring process.

The content information includes index information to be referred to when a music content is reproduced, information for checking possible falsification of the content and information for allowing reproduction for each set. In the data-recording apparatus according to this invention, the coping from the original storage place to the another recording medium is to assign the right of using the content. The apparatus should better be used in combination with a content management method in which the content cannot be used in the original storage place unless the right of moving the content from the another recording medium to the original storage place is reverted.

It is desired that the another recording medium should be one that has a secure region that can be used if verified and an ordinary record region, and that the content should be recorded in the secure region.

Further, to achieve the above-mentioned object, a data-recording system according to this invention comprises: a data-recording apparatus having a first recording means for recording, in a storage means, a content input from an external device, and a second recording means for copying the content from the storage means to another recording medium and recording content information specific to the content and device information specific to the data-recording apparatus, and configured to copy the content to the another recording medium, the content being that which is permitted to be copied only a limited number of times; and a content-restoration control apparatus for collating the content information about the copied content and the device information associated with the content information, with device information about a device in which the content is to be written, when the content is lost in the storage place after the content has been recorded by the second recording means, and for causing the first recording means to perform a process of writing the copied content back into the original storage place when collation is successfully performed. The data-recording apparatus and the content-restoration control apparatus are connected to each other by a network.

The content-restoration control apparatus determines whether the content to be restored was restored in the past in combination with the recording medium storing the content, and performs a process of writing the copied content back into the device if the collation is successfully performed and if the content was not restored in the past. The content-restoration control apparatus may determine whether the device in which the content is to be restored is identical to the device in which the content has been previously restored, may detect a restoration interval to determine whether a prescribed period has elapsed from a previous restoring process, and may write the copied content back into the device if the collation is successfully performed, if the device in which the content is to be restored is not identical to the device in which the content has been previously restored and if the prescribed period has elapsed from the previous restoring process.

The content information includes index information to be referred to when a music content is reproduced, information for checking possible falsification of the content and information for allowing reproduction for each set. In the data-recording system according to this invention, the coping from the original storage place to the another recording medium is to assign the right of using the content. The system should better be used in combination with a content management method in which the content cannot be used in the original storage place unless the right of moving the content from the another recording medium to the original storage place is reverted.

A data-recording method and a data-recording apparatus according to this invention can restore the content that has been lost due to, for example, the malfunction of a PC, by distinguishing a content illegally obtained as a user copies it in bad faith, from a content downloaded through prescribed procedures but not having undergone check-in/check-out matching. Moreover, the restoring of the content can be utilized to prevent illegal copying of the content. To restore the content, no backup data is required in the data-recording method and data-recording apparatus according to this invention.

### BRIEF DESCRIPTION OF THE DRAWINGS

FIG. 1 is a diagram explaining a first method of uploading a music file in a secondary recording medium into a PC, thereby to restore the music file, in a data-recording apparatus that is an embodiment of this invention;

FIG. 2 is a diagram explaining how music data in a PC is destroyed or lost when a music content is subjected to check-out in a data-recording apparatus that is an embodiment of this invention;

FIG. 3 is a diagram explaining a second method of uploading a music file in a secondary recording medium into a PC, thereby to restore the music file, in a data-recording apparatus that is an embodiment of this invention;

FIG. 4 is a flowchart explaining the process of determining whether a file can be restored or not, in the data-recording apparatus mentioned above;

FIG. 5 is a diagram showing the configuration of a data-recording apparatus that is an embodiment of the present invention;

FIG. 6 is a diagram illustrating the configuration of a media drive unit incorporated in the data-recording apparatus mentioned above;

FIG. 7 is a schematic diagram depicting the area configuration of the surface of a mini disc for use in the present invention;

FIG. 8 is another schematic diagram showing the area configuration on the surface of a mini disc for use in this invention; and

FIG. 9 is a schematic diagram illustrating the area configuration on the surface of a mini disc for use in the invention, in which both audio data and PC-use data are recorded.

### DETAILED DESCRIPTION OF THE PREFERRED EMBODIMENTS

A data-recording apparatus according to the present invention is an apparatus than can handle different types of data in a recording medium, such as audio data and PC-use data, which have been generated in different formats. The recording medium can be any type if that can hold a great amount of data. Thus, it may be a semiconductor memory, a disc-shaped recording medium, or the like. In the present embodiment, nonetheless, the medium is a mini disc (trademark) that is a magnetooptical recording medium shaped like a disc.

The data-recording apparatus according to this embodiment can record data in not only the conventional mini disc, but also the next-generation mini disc. The next-generation mini disc can store data at high density, because it is modified so that the track pitch is reduced and the linear velocity and modulation mode are changed. In addition, the next-generation mini disc has not only an ordinary record region, but also a secret region (secure region) that can be used when the disc is verified. The next-generation mini disc adopts a new management-data configuration that differs from UTOC. It can store specific data in an encrypted form, unlike the conventional mini disc that stores data in the form of plain texts only. In the next-generation mini disc, copyrighted data items, such as a music content and a video content, are recorded in the secure region, in a prescribed format. These data items can be reproduced by an apparatus that can refer to the secure region. High-quality music data can be recorded and reproduced for a long time, in and from a mini disc that adopts a new modulation mode. Thus, the number of musical pieces that can be managed in one disc has increased very much. This mini disc is compatible with computers, because the data in it is managed by the use of the FAT file system.

Assume that, in the present embodiment, the content is a music content, and audio data of ATRAC (trademark) format is the specific data that can be recorded in the secure region. Audio data, video data and text data of MP3 (MPEG1 Audio Layer-3) or WMA (Windows Media Audio) format, other than the ATRAC-format data items, are recorded in the ordinary record region. The next-generation mini disc that has a secure region and an ordinary record region will be later described in detail.

The data-recording apparatus according to this embodiment is connected to a data-processing apparatus such as a personal computer that has a data-accumulating unit such as a hard disc drive (HDD). It is a data-recording apparatus that has a data storage unit. The data storage unit stores a copyrighted music content that has been stored into the data storage unit by lipping or dubbing. The content can be copied in another recording medium in predetermined, limited copying conditions. The data-recording apparatus can handle, in a similar way, a music content provided by music-distributing service (EMD: Electronic Music Distribution) that distributes a music content at fixed price through a network such as the Internet.

The data-processing apparatus to which the data-recording apparatus according to this embodiment is connected can therefore function as an EMD player that is configured to playback digital audio data copyrighted to be distributed through networks. The data-recording apparatus accomplishes so-called check-in (right reversion)/check-out (right assignment) matching in an SDMI (Secure Digital Music Initiative) system, thereby to manage the content data.

A method of restoring a music-content file (music file), which is an embodiment of this invention, will be described in detail with reference to the accompanying drawings. In this embodiment, a data-recording apparatus 1 that can record data in a next-generation mini disc 90 is connected to a PC 2 that is a data-processing apparatus. In an SDMI system, the music file is checked out to the mini disc 90 used as secondary recording medium from the PC 2 that has an HDD used as primary recording medium. Thereafter, the music data may be destroyed or lost in the PC 2 having the primary recording medium. In this case, the music file transferred can no longer be reverted. The check-out and the check-in cannot be matched, resulting in a check-in NG. Consequently, the content may no longer be utilized.

Thus, in this embodiment, the music file in the secondary recording medium is uploaded to restore the content. As method of preventing illegal copying of the content in the process of restoring the content, the following two are available.

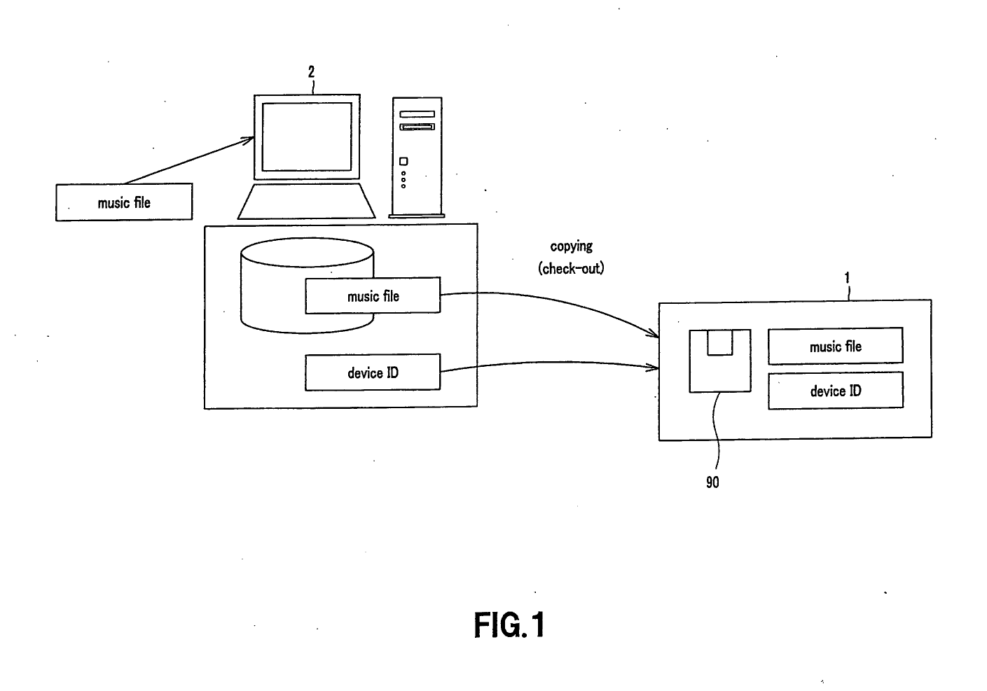

The first method will be explained, with reference to FIG. 1. As schematically shown in FIG. 1, the device ID assigned to the PC 2 is recorded in the mini disc 90 that is the secondary recording medium, when the music data is checked out. In the time of backup restoration, it is determined whether the source of music data to restore is identical to the PC or not. The music data is restored only if the source is identical to the PC from which the data has been checked out.

In the PC 2, which is a data-processing apparatus, the copyrighted music content reproduced from another recording medium, such as a CD, DVD or the like, is stored into the HDD that is a data-accumulating unit. The music file, thus accumulated in the HDD, is copied in the mini disc 90 in the data-recording apparatus 1. At this time, the data-recording apparatus 1 records the ID specific to the PC 2, in the mini disc 90. In practice, the device ID of the PC can be the ID of a network card, the ID of the hard disc, or the like.

The content ID specific to the content is recorded, along with the music file, in the next-generation mini disc used in the present embodiment. Thus, in the SDMI system, the music content has been transferred, from the PC 2 having the HDD used as primary recording medium, to the mini disc 90 used as secondary recording medium, through the data-recording apparatus 1. The content ID contains encryption data such as a track-index file (TIF), a MAC file or an EKB file, which will be used to encrypt a music content. The track-index file must be referred to before the content is reproduced. The MAC file contains MAC, i.e., data that will be used in checking the content to see if the content has been falsified. The EKB file contains an EKB (Enabling Key Block), i.e., information that enables a data-reproducing device to reproduce data.

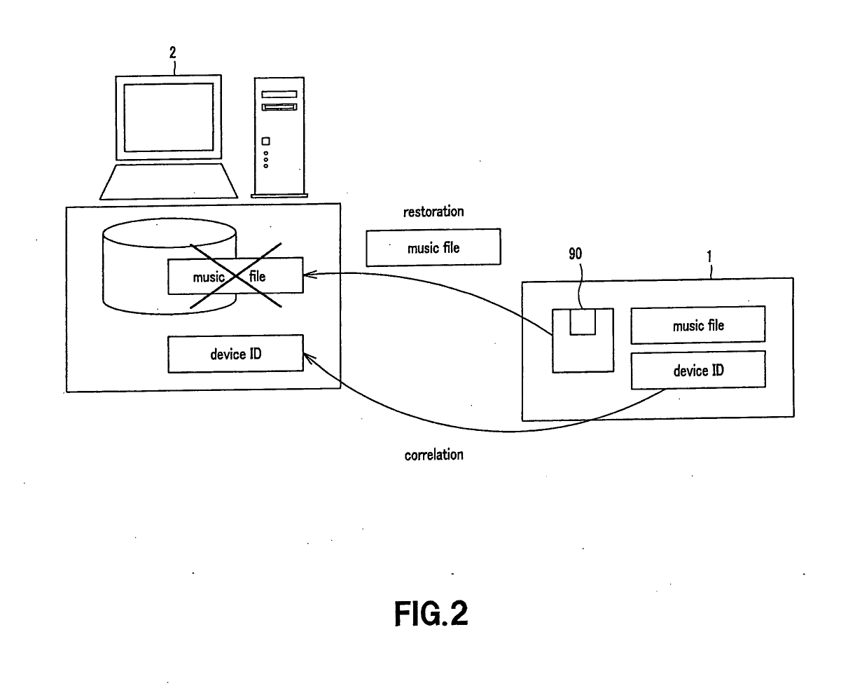

When the content is checked out, the music data in the PC 2 may be destroyed or lost as is illustrated in FIG. 2. Then, the music file transferred cannot be reverted. In this case, the data-recording apparatus 1 collates the music file, to determine whether the device assigned to the source of data to restore is identical or not to the PC 2 that has checked out the music file. That is, the data-recording apparatus 1 compares the device ID of the device designated as source of data to restore, with the device ID of the PC 2 that has been recorded together with the music file at the time of check-out. If the device ID is identical to that of the PC 2, the apparatus 1 transfers the music file recorded in the mini disc 90, to the device connected to the apparatus 1. The music file, i.e., source data destroyed or lost, is thereby restored.

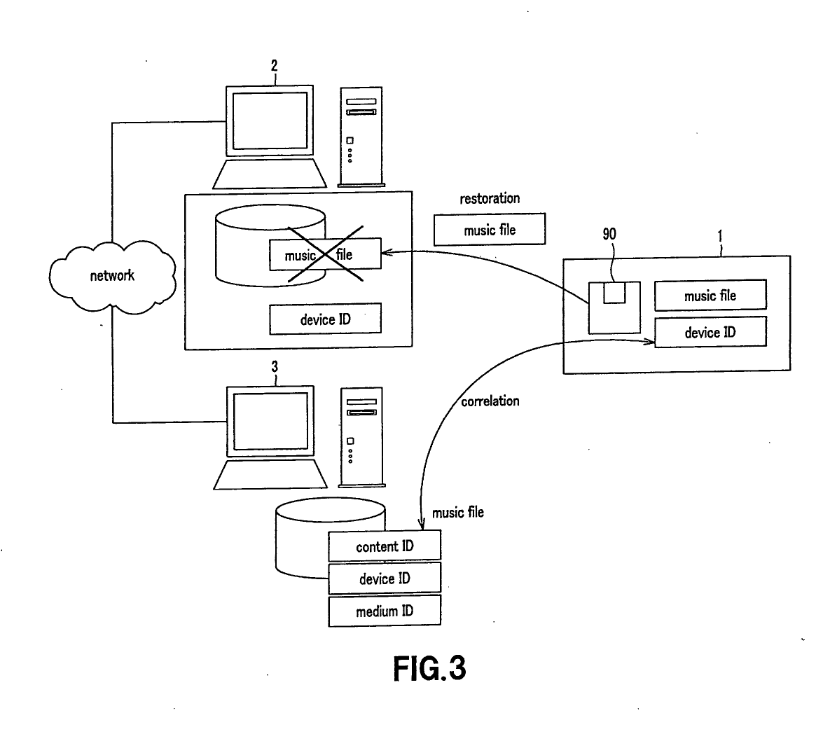

Next, the second method will be explained, with reference to FIG. 3. In the second method, the data-recording apparatus 1, the PC 2 connected to the apparatus 1, and a management device 3 are prepared. The management device 3 is a content-restoration control apparatus for managing copying and restoring of a content. The device 3 stores the device ID of the PC 2 in which the music file is originally stored, the content ID of the music file and the medium ID specific to the mini disc 90, i.e., destination of copied music file. The device ID, content ID and medium ID are stored, each associated with any other ID. The management device 3 is connected to the PC 2 by a network.

When the music file is copied, the management device 3 stores the device ID of the PC 2 in which the music file is originally stored, the content ID of the music file, and the medium ID specific to the mini disc 90 in which the music file is copied. The device ID, content ID and medium ID are stored, as a plurality of histories, each associated with any other. When the PC 2 requests that the music file be restored, the management device 3 collates the content ID recorded in the mini disc 90 to which the music file should be copied, the medium ID and the device ID of the PC 2 with one another. If the histories copied are determined, the management device 3 allows the music file recorded in the mini disc 90 to be written back into the HDD of the PC 2. Hence, it is possible to restore the music file in the PC 2 even if the original music file has been destroyed or lost in the HDD of the PC 2, provided that the histories copied and recorded in the management device 3 show that the music file is one transferred from the PC 2 to the mini disc 90 via the data-recording apparatus 1.

In the second method, it is determined whether a music file has been restored in a prescribed period, in order to prevent the music file from being copied in several PCs within a short time, as if it were restored from the same mini disc. If the music file has not been restored in the prescribed period, it will be restored as requested. In this case, a flag is set in the mini disc 90, said flag indicating whether the copied file has been used, along with the music file, in order to restore the original music file.

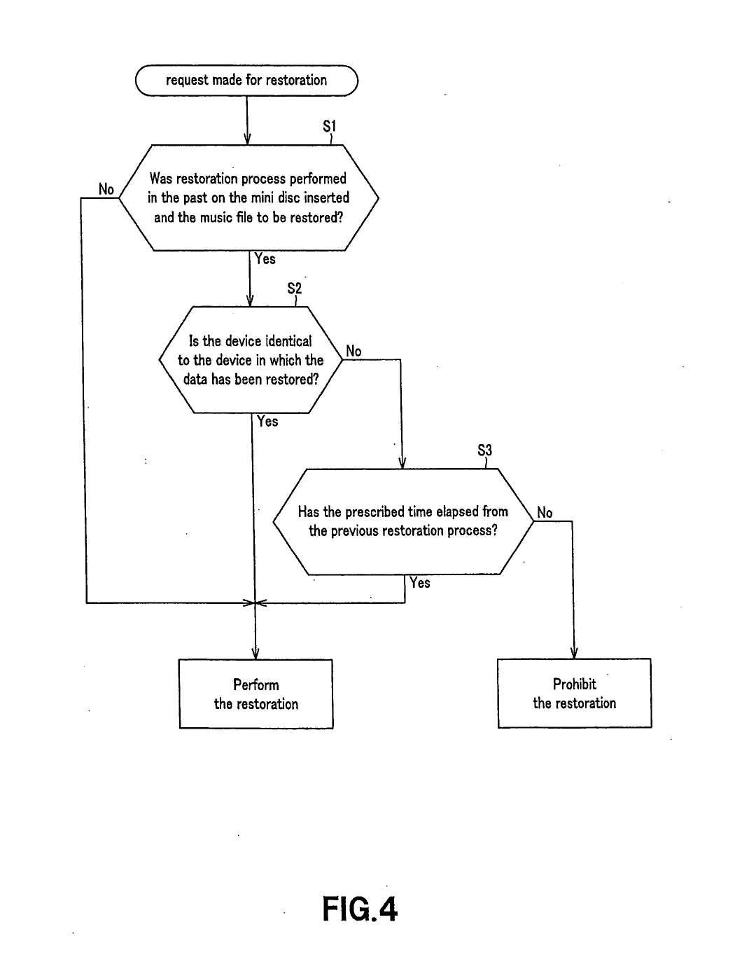

FIG. 4 shows the process that the management device 3 performs to determine whether a file can be restored or not. When the PC 2 makes a restoration request, the management device 3 determines, in Step S1, whether a restoration process was performed in the past by using a combination of the track to be restored and the mini disc 90 inserted for this track. If no restoration process was performed in the past by using this mini disc 90 and the track, a restoration process is permitted. On the other hand, if any restoration process was performed in the past by using this mini disc 90 and the track, the management device 3 determines, in Step S2, whether the device in which data should be restored is identical to the device in which the data has been previously restored. If the device is identical to the device in which the data has been previously restored, the restoration process is carried out. If the device is not identical to the device in which the data has been previously restored, the management device 3 determines, in Step S3, whether or not a prescribed time has elapsed from the previous restoration process. If the prescribed time has elapsed, the restoration process is permitted. If the prescribed time has not elapsed, the restoration process is prohibited.

Thus, in the first and second methods, if a copyrighted file is destroyed or lost in the PC, this file is uploaded from the recording medium to which the file has been checked out, if at least the device ID and the content ID are collated with each other. Namely, the file in the original storage place can be restored, without necessity of using data backed up. In addition, the management device 3 may be provided in a network. Then, the apparatus 3 can manage the restoration history on the basis of the medium ID of the recording medium, the content ID of the music file, the device ID of the PC and the like, thereby preventing illegal restoration.

Such a device ID as described above may change when the PC or the components thereof are replaced with new ones. Thus, in the second method, a music file may be restored in response to a request even if the ID of the PC has changed, provided that no restoration operations were carried out in a predetermined period in the past. Further, the music file may be merely copied from the HDD of the PC 2 to the mini disc 90, no matter whether the file has been checked in or out. In the PC 2, any file can be recorded, regardless of its type. That is, any file can be recorded no matter whether it is a music file, a video file, a data file or the like. Therefore, the data recorded may overflow the storage capacity of the HDD, rendering it necessary to erase part of the data hitherto accumulated in the HDD. In such a case, too, the user need not remember which data has been erased. Note that the data-recording apparatus 1 and the PC 2 may be integrally formed. In other words, the PC 2 may comprise a data-recording apparatus that records data in the mini disc 90.

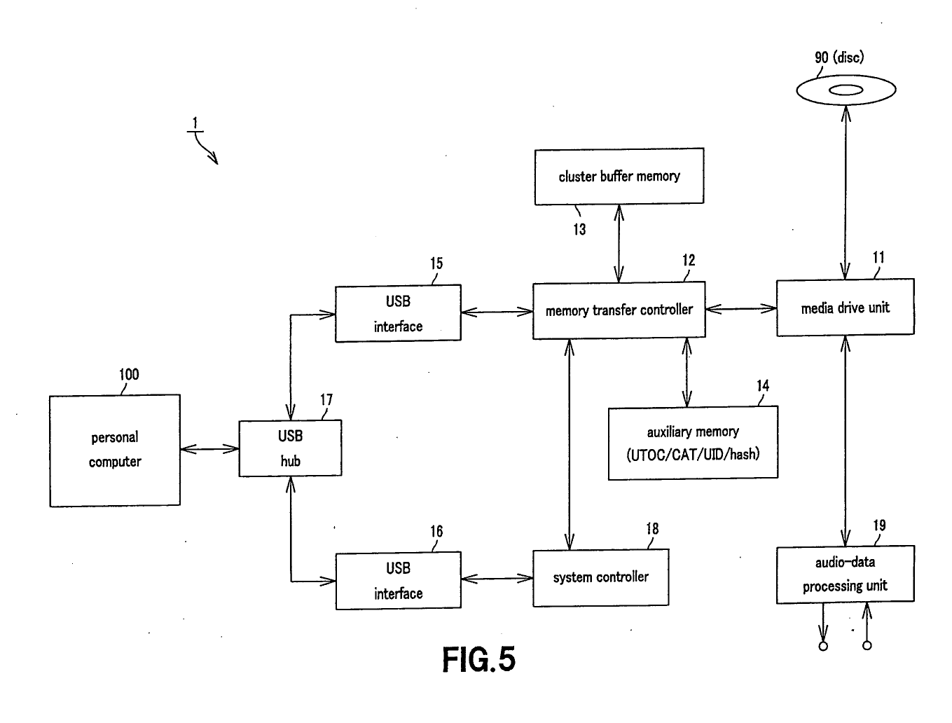

The data-recording apparatus 1, which is an embodiment of the present invention, will be described in detail, with reference to the drawings. The data recorded in the secure region of the mini disc used in this embodiment is an audio file. The audio file is data in ATRAC (Adaptive Transform Acoustic Coding) format, ATRAC3 format or ATRAC3plus format. As FIG. 5 depicts, the data-recording apparatus 1 comprises a media drive unit 11, a memory transfer controller 12, a cluster buffer memory 13, an auxiliary memory 14, USB interfaces 15 and 16, a USB hub 17, a system controller 18, and an audio-data processing unit 19. The data-recording apparatus 1 can be connected to a personal computer (to be abbreviated as PC, hereinafter) 100. The apparatus 1 can use a mini disc as a medium for recording audio data. It can be used as an external storage device to the PC or the like.

In the data-recording apparatus 1, the media drive unit 11 can record data in, and reproduce data from, the mini disc 90. The internal structure of the media drive unit 11 will be described later.

The memory transfer controller 12 controls the transfer of data (reproduced data) from the media drive unit 11, and also the transfer of data (data to be recorded) to the media drive unit 11. The cluster buffer memory 13 performs buffering on the data that the media drive unit 11 has read, cluster by cluster, from a data track of the mini disc 90. The memory 13 carries out this buffering under the control of the memory transfer controller 12. The auxiliary memory 14 stores various items of information under the control of the memory transfer controller 12. The items of information stored are management information, such as UTOC data (read from the mini disc 90), information for copyright protection (recorded in the secure region of the mini disc 90); information for preventing data falsification, information about external devices that can be accessed, and similar information.

The system controller 18 can communicate with the PC 100 that is connected to the PC 100 by the USB interface 16 and USB hub 17. The system controller 18 controls the communication with the PC 100. It receives commands such as write requests and read requests, and transmits status information and other necessary information. In addition, it controls the other components of the data-recording apparatus 1. For example, when the mini disc 90 is inserted into the media drive unit 11, the system controller 18 instructs the media drive unit 11 to read management information and the like from the mini disc 90. The system controller 18 causes the auxiliary memory 14 to store the management information read by the memory transfer controller 12, such as PTOC and UTOC. From the management information thus stored in the memory 14, the system controller 18 determines the recorded state of the tracks of the mini disc 90. A region for recording content management information is provided at the innermost annular region of the mini disc 90 when the disc is initialized. Note that the content management information includes the file information about the content data to be recorded and information about encrypted units of the content data to be recorded.

Upon receiving a request for reading data from the PC 100, which requests that data be read from an FAT sector, the system controller 18 supplies a signal to the media drive unit 11, causing the unit 11 to read the data cluster containing this FAT sector. The data cluster thus read is written in the cluster buffer memory 13 by means of the memory transfer controller 12. Nonetheless, the media drive unit 11 need not read the data cluster if the cluster buffer memory 13 has already stored the data recorded in the FAT sector. If this is the case, the system controller 18 supplies a signal for reading the data from the FAT sector written in the cluster buffer memory 13. The data read from the cluster buffer memory 13 is transmitted to the PC 100 via the USB interface 15 and USB hub 17. Alternatively, the system controller 18 performs a control to reproduce audio data.

Upon receiving, from the PC 100, a request for writing data in an FAT sector, the system controller 18 causes the media drive unit 11 to read the data cluster including the FAT sector, in accordance with the information stored in the auxiliary memory 14. The data cluster thus read is written in the cluster buffer memory 13 by means of the memory transfer controller 12. Nevertheless, the media drive unit 11 need not read the data cluster if the cluster buffer memory 13 has already stored the data recorded in this FAT sector. The system controller 18 supplies the data recorded in the FAT sector, which has been transmitted from the PC 100, to the memory transfer controller 12 via the USB interface 15. The system 18 causes the controller 12 to rewrite the data of the FAT sector, in the cluster buffer memory 13.

The system controller 18 instructs the memory transfer controller 12 to transfer the data of the data cluster, as data to be recorded, to the media drive unit 11. Note that the data of the data cluster is stored in the cluster buffer memory 13, in which the necessary FAT sector has been rewritten. In the media drive unit 11, the data of the data cluster is modulated in the mode assigned to the mini disc incorporated in the media drive unit 11.

In the present embodiment, the mini disc 90 has a secure region and an ordinary record region, and prescribed data is recorded in each region. Therefore, the system controller 18 instructs the media drive unit to access a region on the disc, in accordance with whether the data to be reproduced is recorded in an audio track or a data track. In the data-recording apparatus 1, the PC-use data or the audio data, not both, may be recorded in the mini disc 90, prohibiting the recording of any other data. That is, a control can be performed not to record both the PC-use data and the audio data.

In the data-recording apparatus 1, i.e., an embodiment of the invention, the recording-reproducing control described above is performed to control the data-recording in, and -reproducing from, data tracks. The transfer of data performed to record or reproduce MD audio data (in and from audio tracks) is carried out by the audio-data processing unit 19.

The audio-data processing unit 19 comprises an analog-audio-signal input unit, an A/D converter and a digital-audio-data input unit, which constitute an input system. The analog-audio-signal input unit is, for example, a line input circuit/microphone input circuit. The audio-data processing unit 19 further comprises an ATRAC-compression encoder/decoder and a buffer memory for storing compressed data. The audio-data processing unit 19 further comprises a digital-audio-data output unit, a D/A converter and a line-output circuit/headphone output circuit, which constitute an output system, or an analog-audio signal output unit.

An audio track is recorded in the mini disc 90 when digital audio data (or analog audio signal) is input to the audio-data processing unit 19. Either linear PCM-digital-audio data input or the linear PCM audio data that the A/D converter has generated from an analog audio signal is subjected to ATRAC compression encoding and accumulated in the buffer memory. Thereafter, the data is read from the buffer memory at a predetermined timing (in the form of data units equivalent to ADIP clusters). The data thus read is transferred to the media drive unit 11. In the media drive unit 11, the compressed data transferred is modulated in EFM mode or RLL(1-7)PP mode. The data thus modulated is written, as an audio track, in the secure region of the mini disc 90. The data compressed in a compression mode other than the ATRAC mode is written, as ordinary data, in the ordinary record region.

When an audio track is reproduced from the mini disc 90, the media drive unit 11 demodulates the reproduced data into ATRAC-compressed data. The ATRAC-compressed data is transferred to the audio-data processing unit 19. The audio-data processing unit 19 performs ATRAC-compression decoding on the data, generating linear PCM audio data and outputting it through the digital-audio-data output unit. Alternatively, the D/A converter may convert the data to an analog audio signal, which is output to the line-output circuit/headphone output circuit.

The configuration of FIG. 5 is no more than an example. The audio-data processing unit 19 is unnecessary if the data-recording apparatus 1 is connected to the PC 100 and used as an external storage device that records and reproduces data tracks only. If the main objective of the apparatus 1 is to record and reproduce audio signals, the apparatus 1 should preferably comprise not only the audio-data processing unit 19, but also an operation unit and a display unit that are employed as user interfaces. The apparatus 1 is connected to the PC 100 by USB interfaces. Instead, it may be connected to the PC 100 by, for example, so-called IEEE 1394 interfaces or general-purpose connection interfaces. IEEE 1394 interfaces conform to the standards defined by IEEE (The Institute of Electrical and Electronics Engineers, Inc.).

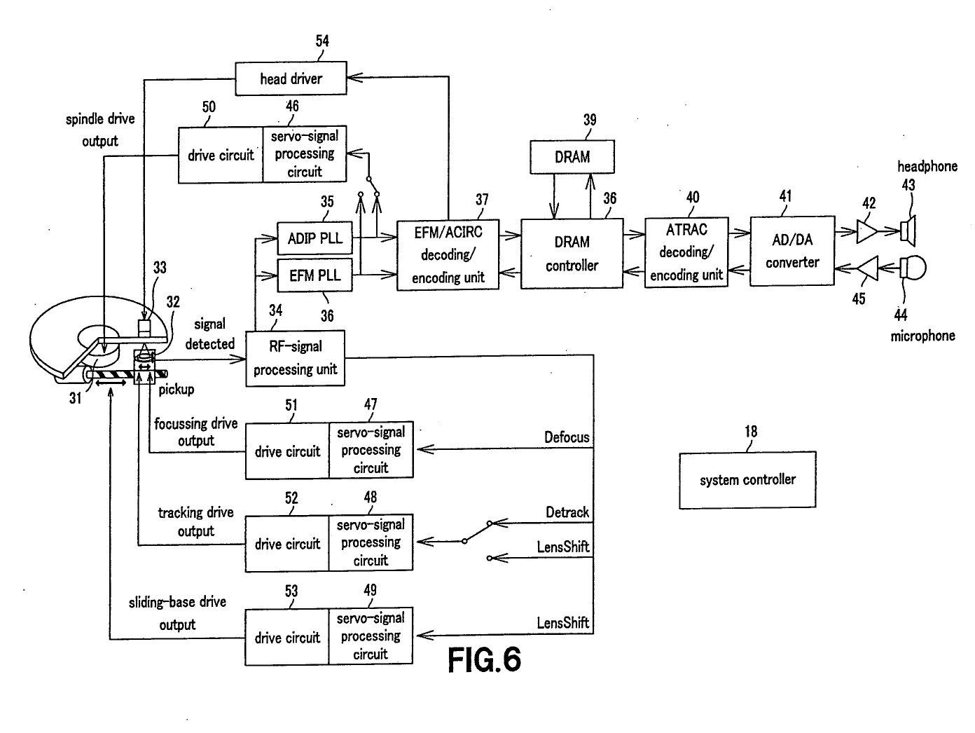

The media drive unit 11 and audio-data processing unit 19 of the data-recording apparatus 1 will be described in detail, with reference to FIG. 6. The data-recording apparatus 1 according to the present invention is characterized in that image data is reproduced in association with data that can be linked to it, in accordance with link information. The link information represents a format that enables specific image data items to be linked, said data items being some of those that have been generated in different formats and recorded in a mini disc having a secure region and an ordinary record region. Particularly, the link information is an association table showing a format that enables the specific image data items to be linked to the audio data generated in different formats and recorded in the secure region.

The media drive unit 11 has a recording system that performs EFM-modulation and ACIRC encoding to record data in the mini disc 90. EFM-modulation and ACIRC encoding are a recording mode for the mini disc 90. The unit 11 also has a reproducing system that performs EFM-demodulation and ACIRC decoding to reproduce data from the mini disc 90. The media drive unit 11 has a spindle motor 31 and an optical head 32. The spindle motor 31 rotates the mini disc 90 inserted in the unit 11, in either CLV mode or ZCAV mode. The optical head 32 applies a laser beam to the mini disc 90, to record data in, or reproduce data from, the mini disc 90.

The optical head 32 emits a laser beam intense enough to heat a record track to the Curie temperature, in order to record data in the record track. To reproduce data, the head 32 emits a laser beam that has relatively low intensity. The light reflected by the disc is detected from the beam reflected by virtue of the Kerr magnetic effect. To detect the data, the optical head 32 has a laser diode, an optical system, and a detector. The laser diode is the beam-emitting means. The optical system comprises a polarized beam splitter, an objective lens and the like. The detector detects the light reflected by the disc. The objective lens incorporated in the optical head 32 is supported by, for example, a 2-axis mechanism and can move in the radial direction of the disc, and toward and away from the disc.

In this embodiment, data can be recorded in, and reproduced from, mini discs of various types that differ in the surface physical property. To attain the best possible reproduction characteristic for these discs, a phase-compensating plate is arranged in the reading-light path of the optical head 32. The phase-compensating plate can optimize the bit-error rate in the course of reading data.

A magnetic head 33 is arranged, opposed to the optical head 32 across the mini disc 90. The magnetic head 33 applies a magnetic field to the mini disc 90, said magnetic field having been modulated with the data that is to be recorded. Further, a thread motor (not shown) and a thread mechanism (not shown, either) are provided to move the optical head 32 and magnetic head 33 in the radial direction of the disc.

The media drive unit 11 has not only the recording-reproducing head system comprising the optical head 32 and magnetic head 33 and the disc-rotating system comprising the spindle motor 31, but also a recording system, a reproducing system, a servo system and the like. The recording system includes a unit for performing EFM modulation and a unit for effecting ACIRC encoding, thereby to record data in the mini disc 90. The reproducing system includes a unit for carrying out EFM demodulation and a unit for performing ACIRC decoding, thereby to reproduce data from the mini disc 90.

The optical head 32 applies a laser beam to the mini disc 90. The beam is reflected from the disc 90. Information is detected from the laser beam reflected. The information (i.e., photocurrent generated by a photodetector that has detected the laser beam reflected) is supplied to an RF-signal processing unit 34. The RF-signal processing unit 34 performs current-to-voltage conversion, amplification and matrix operation on the input information. Thus, the unit 34 extracts, from the information, a reproduced RF signal, a tracking-error signal TE, a focusing-error signal FE, group data (i.e., ADIP data recorded in the mini disc 90 by virtue of the wobbling of the tracks), and the like.

In order to reproduce data from the mini disc 90, the reproduced RF signal obtained in the RF-signal processing unit 34 is supplied via an ADIP_PLL circuit 35 and an EFM_PLL circuit 36 to an EFM and/or ACIRC encoding/decoding unit (EFM/ACIRC codec) 37. The unit 37 processes the RF signal. The tracking-error signal (Detrack), focusing-error signal (Defocus) and lens-shift signal (LensShift) output from the RF-signal processing unit 34 are supplied to each servo-signal processing circuit. The group data is supplied to the ADIP_PLL circuit 35. The ADIP_PLL circuit 35 has a band-pass filter, which extracts a wobble component from the group data. The circuit 35 then performs FM demodulation and bi-phase demodulation on the group data, extracting an ADIP address. The group data is fed back to a servo-signal processing circuit 46 so that spindle-servo control may be accomplished.

The RF signal reproduced is supplied to the EFM and/or ACIRC encoding/decoding unit 37. The unit 37 digitizes the RF signal, generating an EFM-signal string. The EFM-signal string is subjected to EFM demodulation. Further, the EFM-signal string undergoes error correction and a de-interleave process so that it may be ACIRC-demodulated. If the string is audio data, it assumes the state of ATRAC-compressed data at this point of time. The ATRAC-compressed data, thus demodulated, is output via a memory controller 38 to a DRAM 39, as data reproduced from the mini disc 90. Subsequently, the data undergoes ATRAC decoding in an ATRAC encoding/decoding unit (ATRAC codec) 40. The data thus decoded is supplied via an AD/DA converter 41 and an amplifier 42 to an output unit 43. The output unit 43, such as a headphone or a speaker, outputs the data. The data-recording apparatus 1 acquires external sound through the AD/DA converter 41, a microphone 44, and an amplifier 45.

The servo-signal processing circuit 46 generates a spindle-error signal from an error signal obtained by integrating the phase difference between the group data and a reproduced clock signal (i.e., a PLL-system clock signal used in decoding). The spindle-error signal is supplied to a drive circuit 50. Servo-signal processing circuits 47, 48 and 49 generate various servo-control signals (i.e., a tracking-control signal, a focusing-control signal, a thread-control signal, a spindle-control signal) from the tracking-error signal, focusing-error signal, lens-shift command, track-jump command, access command and the like, all supplied from the RF-signal processing unit 34. The servo-control signals generated by the circuits 47, 48 and 49 are output to drive circuits 51, 52 and 53. That is, each servo-signal processing circuit performs a phase-compensating process, a gain process, a target-value setting process and the like on a servo-error signal or a command, thereby generating a servo-control signal.

The drive circuits 50, 51, 52 and 53 generate servo-drive signals from the servo-control signals that the servo-signal processing circuits have supplied. Among these servo-drive signals are: two 2-axis drive signals that drive the 2-axis mechanism (for driving the mechanism in the focusing direction and tracking direction, respectively); a thread-motor drive signal that drives the thread mechanism; and a spindle-motor drive signal that drives the spindle motor 31. These servo-drive signals perform the focusing and tracking with respect to the mini disc 90 and the CLV control or ZCAV control with respect to the spindle motor 31.

To record data in the mini disc 90, the memory transfer controller 12 shown in FIG. 5 supplies data, or the audio-data processing unit 19 supplies ordinary ATRAC-compressed data. The EFM and/or ACIRC encoding/decoding unit 37 performs its function when data is recorded in the midi disc 90. If generated from an audio signal, the compressed data is supplied from the audio-data processing unit 19 to the ACIRC encoder. The ACIRC encoder adds an interleave code and an error-correction code to the compressed data. The compressed data is then EFM-modulated. The data EFM-modulated is supplied to a magnetic head driver 54. Driven by the head driver 54, the magnetic head 33 applies the magnetic field based on the EFM-modulated data. The modulated data is thereby recorded.

In this embodiment, the mini disc 90 has a secure region and an ordinary record region, and the prescribed data is recorded in each region. Therefore, the system controller 18 instructs the media drive unit to access the record region designated in accordance with whether the data to reproduce is an audio track or a data track. In the data-recording apparatus 1, only PC-use data or audio data can be recorded in the mini disc 90 incorporated in the apparatus 1, thus prohibiting the recording of any other data. In other words, a control can be performed not to record both the PC-use data and the audio data.

Subsequently, the mini disc 90, which can be used in the data-recording apparatus 1, will be described. The mini disc 90 may be a conventional magnetooptical recording medium modified in modulation mode, or a recording medium of a format different from the format usually applied to conventional magnetooptical mini discs. The latter medium is better in terms of security and has a greater storage capacity than the former.

The mini disc 90 can have a great storage capacity, while being compatible with the conventional mini discs in respect of case shape and recording/reproducing optical system. This is because the high-density recording technique and the new file system are applied to the mini disc 90. The mini disc 90 can, of course, be of one that adopts the conventional magnetooptical specification and is yet improved in security since it has an area for recording information for copyright protection, information for preventing data falsification and other undisclosed information.

Audio tracks or data tracks are recorded in the mini disc 90, each being not necessarily a physically continuous. Each track may be recorded in the form of parts that are spaced apart from one another. Each of the “parts” is a physically continuous region. If there are two PC-use data record regions that are physically spaced from each other, they may be counted as one data track in one case, and as two data tracks in another case.

A specification that the mini disc 90 may have will be described. First, the specification of the conventional mini disc will be explained. The physical format of the mini disc (and MD-DATA) is specified as follows. The track pitch is 1.6 μm, the bit length is 0.59 μm/bit. The laser-beam wavelength λ is 780 nm (λ=780 nm), and the numerical aperture NA of the optical head is 0.45 (NA=0.45). The recording mode is the groove-recording mode, in which grooves (i.e., groove cut in the surface of the disc) are used as tracks in both data-recording and data-reproducing. The address mode is of the type in which a single spiral groove cut in the surface of the disc. In this mode, the wobbled grooves cut on both sides of the spiral groove provide wobbles, which represent addresses data items. The absolute addresses represented by the wobbles are called “ADIPs (Addresses in Pregroove)” in the present specification. The conventional mini disc adopts EFM (8-14 conversion) demodulation mode. The error-correction mode is ACIRC (Advanced Cross Interleave Reed-Solomon Code). The data interleave employed is of a convolution type. Thus, the data redundancy is 46.3%. The method of detecting data, used for the conventional mini disc, is bit-by-bit method. The disc-driving mode is CLV (Constant Linear Velocity). The linear velocity specified for CLV is 1.2 m/s. The standard data rate applied to the data-recording and -reproducing is 133 kB/s, and the storage capacity is 164 MB (140 MB for MD-DATA). The minimum data unit (cluster) that can be rewritten is composed of 32 main sectors and 4 link sectors, i.e. 36 sectors.

By contrast, a disc for use in the present embodiment, which differs from the conventional mini disc in modulation mode, has the same physical specification as the conventional mini disc described above. Namely, the track pitch is 1.6 μm, the laser-beam wavelength λ is 780 nm (λ=780 nm), and the numerical aperture NA of the optical head is 0.45 (NA=0.45). The recording mode is the groove-recording mode, and the address mode is ADIP. Thus, the optical system, ADIP address-reading mode, servo-control processing in the disc drive are similar to those adopted to the conventional mini disc. The disc is therefore compatible with the conventional mini disc. The data-modulating mode adopted for this disc adopts is RLL(1-7)PP modulation mode (RLL: Run Length Limited, PP: Parity preserve/Prohibit rmtr (repeated minimum transition runlength). The error-correction mode is RS-LDC (Reed Solomon-Long Distance Code) with BIS (Burst Indicator Subcode). The data interleave is of the block-completed type. The data redundancy is therefore 20.50%. The method of detecting data is the viterbi-decoding method that utilizes PR(1,2,1)ML.

In this case, the mode of driving the disc is CLV mode and the linear velocity in this mode is 2.4 m/s. The standard data rate applied to the data-recording and -reproducing is 4.4 MB/s. In this disc-drive mode, the total storage capacity can be as much as 300 MB. The modulation mode may, be changed from EFM mode to RLL(1-7)PP modulation mode. The window margin can then be 0.5 to 0.666, which increases the data-recording density 1.33 times. The cluster, i.e., the minimum data unit, is composed of 16 sectors, namely 64 kB. Since the recording modulation mode is changed from CIRC mode to RS-LDC with BIS mode, in which the viterbi-decoding method is performed, the data efficiency increases from 53.7% to 79.5%. The data-recording density is therefore as 1.48 times as much. To sum it up, the storage capacity can be 300 MB, which is about two times as much as with the conventional mini disc. More specifically, this mini disc 90 is a recording medium that adopts a high-density recording technique such as domain wall displacement detection (DWDD). It differs from the conventional mini disc in terms of physical format. In the mini disc 90, the track pitch is 1.25 μm, the bit length is 0.16 μm/bit. The recording density is high in the linear direction. In order to be compatible with the conventional mini disc, the optical system, reading mode, servo process and the like comply with the conventional standards. Namely, the laser-beam wavelength λ is 780 nm (λ=780 nm), and the numerical aperture NA of the optical head is 0.45 (NA=0.45). The recording mode is the groove-recording mode, and the address mode is ADIP. This mini disc 90 is identical in case shape, too, to the conventional mini disc.

Nevertheless, the limited conditions concerning detrack margin, crosstalk from the lands and grooves, crosstalk of wobbles, focus leaking, CT signals, and the like should be overcome in order to read the track pitch smaller than that of the conventional mini disc and the linear density (bit length), by means of an optical system that is equivalent to the optical system used for the conventional mini disc. This is why the mini disc 90 differs from the conventional one in terms of the depth, inclination and width of grooves. More precisely, the groove depth is 160 nm to 180 nm, the groove inclination is 60° to 70°, and the groove width is 600 nm to 800 nm.

The mini disc 90, which adopts a signal mode that differs in record format, employs RLL(1-7)PP modulation mode (RLL: Run Length Limited, PP: Parity preserve/Prohibit rmtr (repeated minimum transition runlength) as mode of modulating record data. The error-correction mode is RS-LDC (Reed Solomon-Long Distance Code) with BIS (Burst Indicator Subcode). The data interleave is of the block-completed type. The data redundancy is therefore 20.50%. The method of detecting data is the viterbi-decoding method that utilizes PR(1-1)ML. The cluster, i.e., the minimum data unit, that can be rewritten, is composed of 16 sectors, namely 64 kB.

The disc-driving mode adopted in this case is ZCAV mode, in which the linear velocity is 2.0 m/s. The standard data rate applied to the data-recording and -reproducing is 9.8 MB/s. Thus, the total storage capacity of the mini disc 90 can be as much as 1 GB, by adopting the ZCAV mode and DWDD mode.

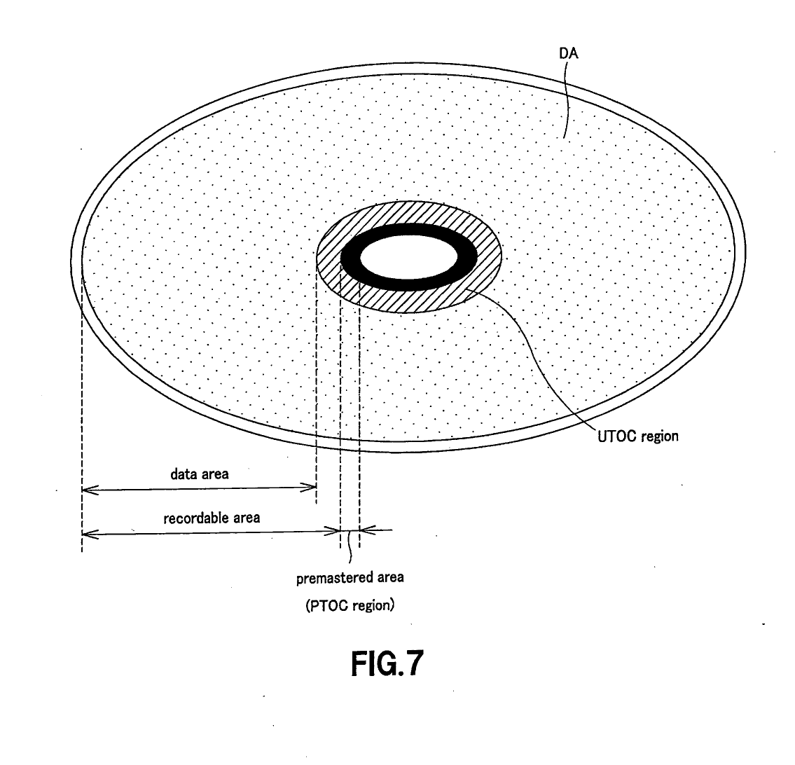

Area configurations that the mini disc 90 according to this embodiment are schematically shown in FIG. 7. The mini disc 90 has a PTOC (Premastered Table Of Contents) region, which is the innermost annular region used as premastered area. In this area, disc-management information is recorded in the form of emboss pits, i.e., physical structure deformation. The annular region surrounding the premastered area is a recordable area in which data can be magnetooptically stored. Data can be recorded in, and reproduced from, the recordable area. In the recordable area, grooves are cut to guide record tracks. The innermost annular region of the recordable area is a UTOC (User Table Of Consents) region. UTOC information is described in the UTOC region. In the UTOC region there are provided a buffer area and a power-calibration area. The buffer area lies in contact with the premastered area. The power-calibration area is used to adjust the output power of the laser beam.

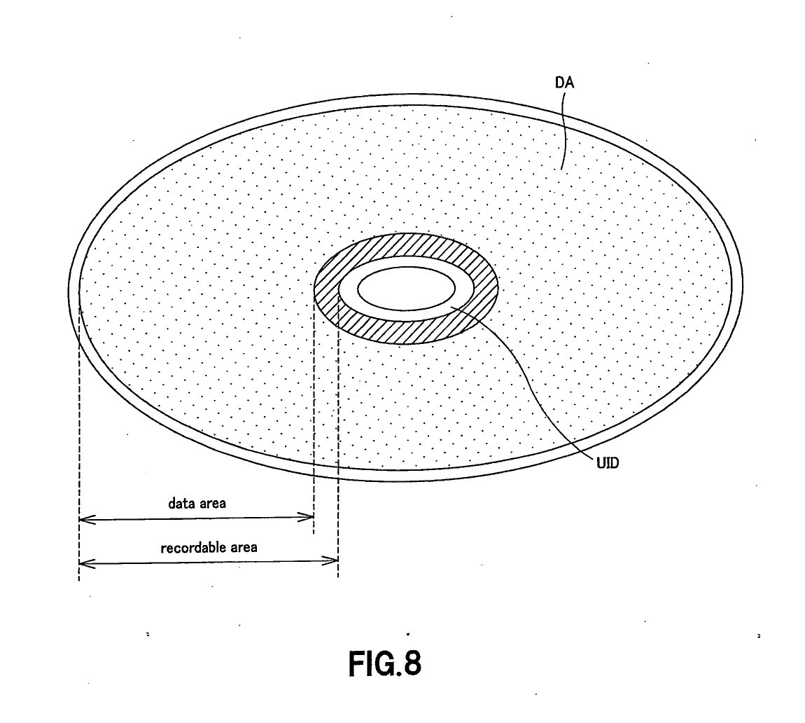

As FIG. 8 shows, the mini disc 90 may have no prepits, so that data may be recorded at high density. The mini disc has no POTC regions. This is because it adopts a signal mode, whose record format differs from the format usually used in the system for recording data in, and reproducing data from, mini discs of the conventional magnetooptical recording scheme. This mini disc 90 has an unique ID (UID) area, which is an annular region lying inside the recordable area. The UID area is provided to store information for copyright protection, information for preventing data falsification and other undisclosed information. In the UID area, information is recorded in a mode that differs from the DWDD mode applied to the mini disc 90.

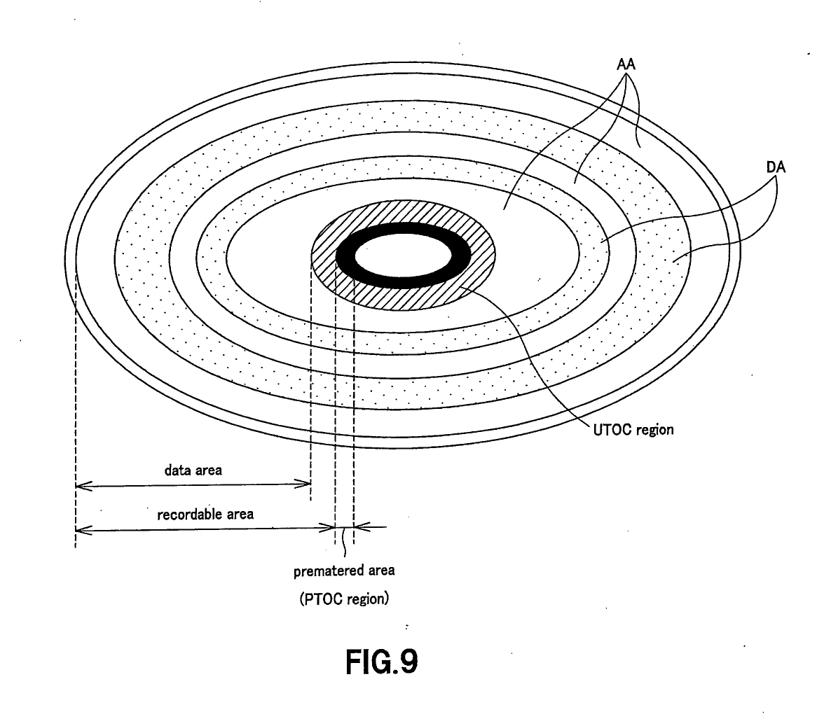

Audio tracks and data tracks for music data can be recorded in each of the discs described above. If this is the case, as shown in FIG. 9, the data area will have an audio-record area AA in which at least one audio track is recorded, and a data-record area DA in which at least one data track is recorded. The area DA is provided for recording PC-use data.

In the data-recording apparatus 1 described above, even if a copyrighted file is destroyed or lost in the PC, the file is uploaded from the recording medium to which the file has been checked out, provided that at least the device ID is collated with the content ID, i.e., information described in the UID area. Thus, the file in the original storage place can be restored, without necessity of using data backed up.

The present invention can be applied as a method of restoring data destroyed or lost in the primary recording medium while it is being used in the secondary recording medium after having been copied from the primary recording medium to the secondary recording medium.

What is claimed is:

1. A data-recording method of copying a content to another recording medium, the content being that which is permitted to be copied only a limited number of times, said method comprising:
a recording step of first copying the content to the another recording medium and then recording content information specific to the content and device information specific to a device that is an original storage place of the content;
a collating step of collating the content information about the copied content and the device information associated with the content information, with device information about a device in which the content is to be written, when the content is lost in the storage place after the content has been recorded in the recording step; and
a restoring step of writing the copied content back into the device when collation is successfully performed in the collating step.

2. The data-recording method according to claim 1, wherein the restoring step has a determining step of determining whether the content to be restored was restored in the past in combination with the recording medium storing the content, and the copied content is written back into the device if the collation is successfully performed in the collating step and if the content was not restored in the past.

3. The data-recording method according to claim 2, wherein the restoring step has a step of determining whether the device in which the content is to be restored is identical to the device in which the content has been previously restored, and a step of detecting a restoration interval to determine whether a prescribed period has elapsed from a previous restoring process, and the copied content is written back into the device if the collation is successfully performed in the collating step, if the device in which the content is to be restored is not identical to the device in which the content has been previously restored and if the prescribed period has elapsed from the previous restoring process.

4. The data-recording method according to claim 1, wherein the content information includes index information to be referred to when a music content is reproduced, information for checking possible falsification of the content and information for allowing reproduction for each set.

5. The data-recording method according to claim 1, wherein the coping from the original storage place to the another recording medium is to assign the right of using the content, and the content cannot be used in the original storage place unless the right of moving the content from the another recording medium to the original storage place is reverted.

6. The data-recording method according to claim 1, wherein the another recording medium has a secure region that can be used if verified and an ordinary record region, and the content is recorded in the secure region.

7. The data-recording method according to claim 1, wherein the content includes a music content and a video content.

8. A data-recording apparatus for copying a content to another recording medium, the content being that which is permitted to be copied only a limited number of times, said apparatus comprising:
first recording means for recording, in storage means, a content input from an external device;
second recording means for copying the content from the storage means to the another recording medium and recording content information specific to the content and device information specific to the data-recording apparatus; and
restoring means for collating the content information about the copied content and the device information associated with the content information, with device information about a device in which the content is to be written, when the content is lost in the storage place after the content has been recorded to the another recording medium by the second recording means, and for causing the first recording means to perform a process of writing the copied content back into an original storage place when collation is successfully performed.

9. The data-recording apparatus according to claim 8, wherein the restoring means determines whether the content to be restored was restored in the past in combination with the recording medium storing the content, and performs a process of writing the copied content back into the device if the collation is successfully performed and if the content was not restored in the past.

10. The data-recording apparatus according to claim 9, wherein the restoring means determines whether the device in which the content is to be restored is identical to the device in which the content has been previously restored, detects a restoration interval to determine whether a prescribed period has elapsed from a previous restoring process, and writes the copied content back into the device if the collation is successfully performed, if the device in which the content is to be restored is not identical to the device in which the content has been previously restored and if the prescribed period has elapsed from the previous restoring process.

11. The data-recording apparatus according to claim 8, wherein the content information includes index information to be referred to when a music content is reproduced, information for checking possible falsification of the content and information for allowing reproduction for each set.

12. The data-recording apparatus according to claim 8, wherein the coping from the original storage place to the another recording medium is to assign the right of using the content, and the content cannot be used in the original storage place unless the right of moving the content from the another recording medium to the original storage place is reverted.

13. The data-recording apparatus according to claim 8, wherein the another recording medium has a secure region that can be used if verified and an ordinary record region, and the content is recorded in the secure region.

14. The data-recording apparatus according to claim 8, wherein the content includes a music content and a video content.

15. A data-recording system comprising:
a data-recording apparatus having first recording means for recording, in storage means, a content input from an external device, and second recording means for copying the content from the storage means to the another recording medium and then recording content information specific to the content and device information specific to the data-recording apparatus, and configured to copy the content to the another recording medium, the content being that which is permitted to be copied only a limited number of times; and
a content-restoration control apparatus for collating the content information about the copied content and the device information associated with the content information, with device information about a device in which the content is to be written, when the content is lost in the storage place after the content has been recorded to the another recording medium by the second recording means, and for causing the first recording means to perform a process of writing the copied content back into an original storage place when collation is successfully performed.

16. The data-recording system according to claim 15, wherein the content-restoration control apparatus determines whether the content to be restored was restored in the past in combination with the recording medium storing the content, and performs a process of writing the copied content back into the device if the collation is successfully performed and if the content was not restored in the past.

17. The data-recording system according to claim 16, wherein the content-restoration control apparatus determines whether the device in which the content is to be restored is identical to the device in which the content has been previously restored, detects a restoration interval to determine whether a prescribed period has elapsed from a previous restoring process, and writes the copied content back into the device if the collation is successfully performed, if the device in which the content is to be restored is not identical to the device in which the content has been previously restored and if the prescribed period has elapsed from the previous restoring process.

18. The data-recording system according to claim 15, wherein the content information includes index information to be referred to when a music content is reproduced, information for checking possible falsification of the content and information for allowing reproduction for each set.

19. The data-recording system according to claim 15, wherein the coping from the original storage place to the another recording medium is to assign the right of using the content, and the content cannot be used in the original storage place unless the right of moving the content from the another recording medium to the original storage place is reverted.

20. The data-recording system according to claim 15, wherein the another recording medium has a secure region that can be used if verified and an ordinary record region, and the content is recorded in the secure region.

21. The data-recording system according to claim 15, wherein the content includes a music content and a video content.
